(19) United States
(12) Patent Application Publication
(10) Pub. No.: US 2015/0278796 A1
(43) Pub. Date: Oct. 1, 2015

(54) RESERVING ACCOUNT BALANCE FOR CONCURRENT PAYMENTS IN SECURE OFFLINE PAYMENT SYSTEM

(71) Applicant: GOOGLE INC., Mountain View, CA (US)

(72) Inventors: Fan Jiang, Adliswil (CH); Iyad Assad, Ruschlikon (CH); Aneto Pablo Okonkwo, Zurich (CH)

(73) Assignee: GOOGLE INC., Mountain View, CA (US)

(21) Appl. No.: 14/226,798

(22) Filed: Mar. 26, 2014

(51) Int. Cl. G06Q 20/32; G06Q 20/38

(52) U.S. Cl. CPC G06Q 20/322; G06Q 20/388; G06Q 20/327

(57) ABSTRACT

A method for providing secure offline payments comprises an account system that communicates a signed balance certificate to a user device. The system accesses the user's account, determines the available unlocked funds, creates and signs a balance certificate, and transmits the signed balance certificate to the user device. To complete an offline payment transaction, the user device and a merchant device establish a communication channel. The merchant device transmits a payment request to the user device. A signed withdrawal record and the signed balance certificate are transmitted to the merchant device for verification and completion of the offline payment transaction. The merchant device signs the withdrawal record, transmits it to the user device, and saves it until the merchant device has network access and can transmit the it to the system. The system verifies the withdrawal record and records it in the user's account.

### TECHNICAL FIELD

The present disclosure relates generally to a payment system, and more particularly to methods and systems that allow users to perform payment transactions offline and without network access.

### BACKGROUND

Proximity communication technology has a limited range of one meter or less and can enable merchant device payment technologies. The short communication distances enable customer identification and secure communication between proximity communication enabled devices. Such proximity communication technologies comprise Near Field Communication (NFC), Radio frequency identification (RFID), or Bluetooth Low Energy (BLE). In operation of an NFC transaction, a user “taps” a device, such as an NFC-enabled mobile phone or NFC-enable smart card, to a reader. The reader recognizes the NFC-enabled device when the device is moved within range of the reader, establishes a secure communication channel with the device, and initiates a payment transaction between the reader and the device. In operation of a BLE transaction, a user brings a device, such as a BLE-enabled mobile phone into close proximity of another BLE-enabled device, such as another BLE-enabled mobile phone. The BLE devices detect that they are in proximity of each other and can establish a secure communication channel to initiate a payment transaction.

Mobile communication devices can be utilized in a transaction that involves the exchange of data or information, for example, in financial transactions. Traditionally, a mobile communication device used in a financial transaction is linked to a financial account or contains financial account information. Consequently, when the mobile communication device is used, the reader receives the financial account information and conducts a debit transaction from the financial account, requiring network access to process the on-line transaction. Such conventional mobile communication device enabled financial transactions are inoperable when access to a network or to specific computers on the network is not available.

### SUMMARY

In certain example aspects described herein, a method for providing secure offline payments comprises a user device that requests a deposit of funds into a user account maintained by an account management system and/or requests an up-to-date balance certificate. The request may comprise a request to lock certain funds in the user's account to prevent double spending. The user device request may also comprise a duration that funds are locked and/or a request that certain funds are only available at a certain location. The lock is later removed when the unlocked funds are used, the balance certificate expires, and/or the user requests that the lock is removed. The account management system accesses the user's account management system account, determines the available unlocked funds, creates and signs a balance certificate, and transmits the signed balance certificate to the user device.

To complete an offline payment transaction, the user device and a merchant device establish a communication channel. The merchant device transmits a payment request to the user device, and the user device generates a signed withdrawal record for a payment amount. The signed withdrawal record and the signed balance certificate are transmitted to the merchant device, where the merchant device verifies the signed withdrawal record to confirm the identity of the user device and verifies the signed balance to confirm the availability of the funds to complete the offline payment transaction. The merchant device signs the withdrawal record, transmits it to the user device, and saves it until the merchant device has network access. When the merchant device has network access, it transmits the signed withdrawal certificate to the account management system. The account management system verifies the withdrawal record and records the withdrawal record in the user's account management system account. When the user device requests a new balance certificate, the user device transmits the signed withdrawal record to the account management system, and the account management system verifies the account balance, and creates a new balance certificate.

In certain other example aspects described herein, a computer program product and a system for providing secure offline payments are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an offline payment system, in accordance with certain example embodiments.

FIG. 2 is a block flow diagram depicting a method for processing an offline payment transaction, in accordance with certain example embodiments.

FIG. 3 is a block flow diagram depicting a method for receiving an up-to-date balance certificate from an account management system, in accordance with certain example embodiments.

FIG. 4 is a block flow diagram depicting a method for providing a singed balance certificate to a user device, in accordance with certain example embodiments.

FIG. 5 is a block flow diagram depicting a method for calculating a balance of available funds in a user account, in accordance with certain example embodiments.

FIG. 6 is a block flow diagram depicting a method for processing a payment request received from a merchant device, in accordance with certain example embodiments.

FIG. 7 is a block flow diagram depicting a method for verifying a user device response to a payment request, in accordance with certain example embodiments.

FIG. 8 is a block flow diagram depicting a method for verifying a withdrawal record, in accordance with certain example embodiments.

FIG. 9 is a block diagram depicting a computer machine and module, in accordance with certain example embodiments.

### DETAILED DESCRIPTION OF THE EXAMPLE EMBODIMENTS

### Overview

The example embodiments described herein provide computer-implemented techniques for securely processing an offline payment. In an example embodiment, a user enables an application and authorizes a user device to communicate a request to perform an offline payment transaction to an account management system. In an example embodiment, the user device establishes a communication channel with the account management system and requests to deposit funds into a user account maintained by the account management system and/or requests an up-to-date balance certificate. The account management system accesses the user's account management system account and creates the balance certificate. In an example embodiment, the balance certificate is limited in time (for example, it expires after a predefined amount of time has passed), limited in the number of payment transactions it can be used in (for example, it expires after being used in an offline payment transaction), limited by the amount of funds available for a single offline payment transaction (for example, it can be used for an offline payment transaction under X dollars) and/or limited by a location (for example, it can be used for an offline payment transaction only at a restaurant or only at location Z). The account management system signs the balance certificate with a balance certificate private key and transmits the balance certificate to the user device.

In an example embodiment, only a selected portion of the funds in the user's account management system account are available for each offline payment transaction, and the remaining funds are locked to prevent double spending. In an example embodiment, the user determines the amount and duration of the locked funds. For example, the user submits a request to lock certain funds in the request for a balance certificate. In another example embodiment, the account management system determines the amount and duration of the locked funds. In yet another example, the account management system and the user determine the amount and duration of the locked funds. In an example embodiment, the user requests that certain funds are only available at a certain location (for example, the user only wishes to use funds for mass transit, at restaurants, or in City X). In an example embodiment, the requested lock is removed when the unlocked funds are used, the balance certificate expires, and/or the user requests that the lock is removed.

The user indicates a desire to complete an offline payment transaction with a merchant or other transaction counterparty. In an example embodiment, the user “taps” the user device within a predefined distance of a merchant device, and the devices establish a communication channel. For example, the devices communicate via a near field communication (NFC), Bluetooth, or short-range communication channel. The merchant device transmits a payment request to the user device, and the user device generates a withdrawal record for an amount indicated on the payment request received from the merchant device. In an example embodiment, the user device signs the withdrawal record with an account certificate private key and transmits the signed withdrawal record with the signed balance certificate to the merchant device.

The merchant device verifies the signed withdrawal record using an account certificate public key to confirm the identity of the user device. The merchant device also verifies the signed balance certificate using a balance certificate public key to confirm the balance certificate is not expired and to confirm the availability of the funds to complete the offline payment transaction. In an example embodiment, the merchant device signs the withdrawal record using a merchant device signing certificate, transmits it to the user device, and saves it until the merchant device has network access. In another example embodiment, the merchant device transmits a status code or message to the user device indicating that the transaction was successful. When the merchant device has network access, it transmits the signed withdrawal certificate to the account management system. In an example embodiment, the account management system verifies the withdrawal record using the merchant device signing certificate public key and records the withdrawal record in the user's account management system account. When the user device requests a new balance certificate, the user device transmits the signed withdrawal record to the account management system, and the account management system verifies the account balance, and creates a new balance certificate.

Various example embodiments will be explained in more detail in the following description, read in conjunction with the figures illustrating the program flow.

### Example System Architectures

Turning now to the drawings, in which like numerals indicate like (but not necessarily identical) elements throughout the figures, example embodiments are described in detail.

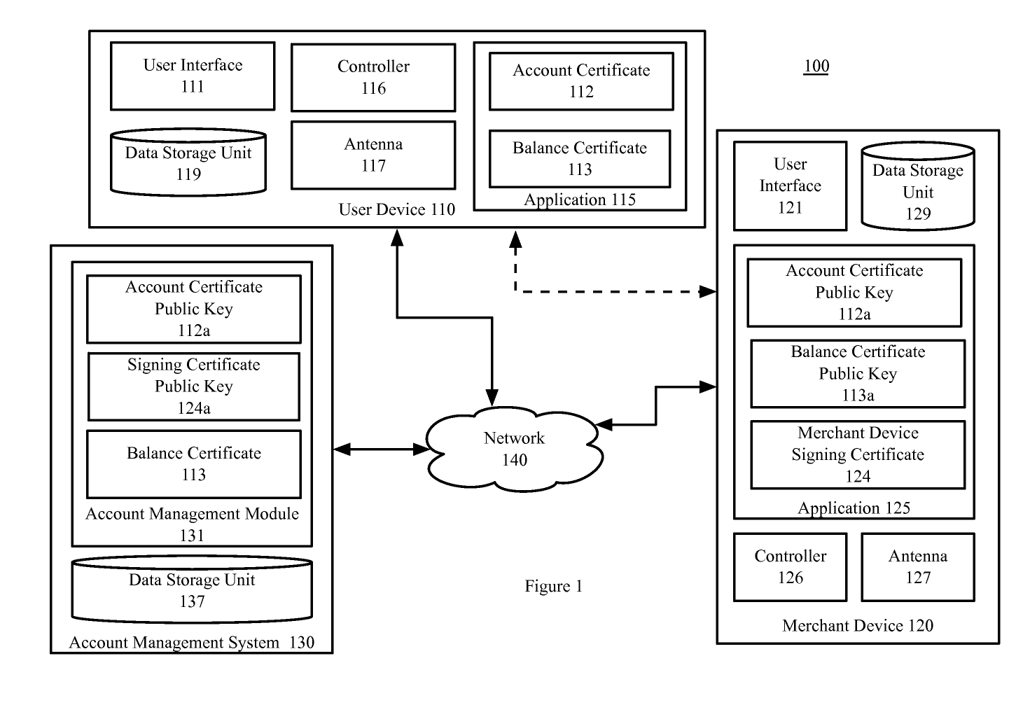

FIG. 1 is a block diagram depicting an offline payment system 100, in accordance with certain example embodiments. As depicted in FIG. 1, the exemplary operating environment 100 comprises a merchant computing device 120, a user computing device 110, and an account management computing system 130 that are configured to communicate with one another via one or more networks 140. In some embodiments, a user associated with a device must install an application and/or make a feature selection to obtain the benefits of the techniques described herein.

In an example embodiment, the user device 110 and the merchant device 120 are configured to communicate directly and exchange information without a network 140 connection. In an example embodiment, the devices (including device 120 and 110) communicate via a proximity communication technology. For example, via a near field communication channel, Bluetooth communication, Bluetooth Low Energy (BLE) communication, a form of standardized radio frequency, infrared, sound (for example, audible sounds, melodies, and ultrasound), other short range communication channel, or system that facilitates the communication of signals, data, and/or messages (generally referred to as data). Throughout this specification, it should be understood that the terms “data” and “information” are used interchangeably herein to refer to text, images, audio, video, or any other form of information that can exist in a computer-based environment.

In another example embodiment, two or more of these systems/devices (including systems/devices 110, 120, and 130) are integrated into the same system or device. In some embodiments, a user associated with a device must install an application and/or make a feature selection to obtain the benefits of the techniques described herein.

Each network 140 includes a wired or wireless telecommunication means by which network systems/devices (including systems/devices 110, 120, and 130) can communicate and exchange data. For example, each network 140 can be implemented as, or may be a part of, a storage area network (SAN), personal area network (PAN), a metropolitan area network (MAN), a local area network (LAN), a wide area network (WAN), a wireless local area network (WLAN), a virtual private network (VPN), an intranet, an Internet, a mobile telephone network, a card network, or any combination thereof, or any other appropriate architecture.

In an example embodiment, each network computing system 110, 120, 130 includes a device having a communication module capable of transmitting and receiving data over the network 140. For example, each network systems/devices (including systems/devices 110, 120, and 130) may comprise a server, personal computer, mobile device (for example, notebook computer, tablet computer, netbook computer, personal digital assistant (PDA), video game device, GPS locator device, cellular telephone, Smartphone, or other mobile device), a television with one or more processors embedded therein and/or coupled thereto, or other appropriate technology that includes or is coupled to a web browser or other application for communicating via the network 140. In the example embodiment depicted in FIG. 1, the network systems/devices (including systems/devices 110, 120, and 130) are operated by merchants, users, and an account management system operator, respectively.

In an example embodiment, the merchant device 120 can refer to a smart communication device that can communicate via an electronic, magnetic, or radio frequency field between the device 120 and another device, such as a user device 110. In an example embodiment, the merchant device 120 has processing capabilities, such as storage capacity/memory and one or more applications 125 that can perform a particular function. In an example embodiment, the merchant device 120 contains an operating system (not illustrated) and user interface 121. Example merchant devices 120 smart phones, mobile phones, personal digital assistants (PDAs), mobile computing devices (for example, netbooks, tablets, and iPads), laptops, wearable computing devices (for example, watches, rings, or glasses), and other devices, in each case having processing and user interface functionality.

In an example embodiment, the controller 126 is a Bluetooth link controller. The Bluetooth link controller 126 may be capable of sending and receiving data, identifying the user device 110, performing authentication and ciphering functions, and directing how the merchant device 120 will listen for transmissions from the user device 110 or configure the merchant device 120 into various power-save modes according to the Bluetooth-specified procedures. In another example embodiment, the controller 126 is a Wi-Fi controller or an NFC controller capable of performing similar functions.

The application 125 is a program, function, routine, applet or similar entity that exists on and performs its operations on a merchant device 120. For example, the application 125 may be one or more of an offline payment application, a digital wallet application, a coupon application, a loyalty card application, another value-added application, a user interface application, or other suitable application operating on the merchant device 120. Additionally, the merchant device 120 may comprise a secure element (not illustrated), which can exist within a removable smart chip or a secure digital (SD) card or which can be embedded within a fixed chip on the device 120. In certain example embodiments, Subscribed Identity Module (SIM) cards may be capable of hosting a secure element, for example, an NFC SIM Card. The secure element allows a software application 125 resident on the device 120 and accessible by the device user to interact securely with certain functions within the secure element, while protecting information stored within the secure element. The secure element may comprise one or more applications 125 running thereon that perform the functionality described herein.

An example merchant device 120 comprises one or more keys and/or certificates. In an example embodiment, the merchant device 120 verifies a withdrawal record received from the user device 110 in response to a payment request. The user device 110 signs the withdrawal record using an account certificate 112 and the merchant device verifies the record using an account certificate public key 112a to confirm the identity of the user device 110. In another example embodiment, the merchant device 110 verifies a balance certificate 113 received from the user device 110 in response to a payment request. The merchant device 120 verifies the balance certificate 113 using a balance certificate public key 113a to confirm the balance certificate 113a is not expired and to confirm the availability of the funds to complete the offline payment transaction. In an example embodiment, the merchant device 120 signs the withdrawal record using a merchant device signing certificate 124 and transmits the signed withdrawal record to the user device 110. Both devices (110 and 120) save the signed withdrawal record the devices (110 and 120) have network 140 access and can transmit the record to the account management system 130.

In an example embodiment, the data storage unit 129 may be implemented in a secure element or other secure memory (not shown) on the merchant device 120 or may be a separate memory unit resident on the merchant device 120. An example data storage unit 129 enables storage of signed withdrawal records until the merchant device 120 has network 140 access and can communicate the signed withdrawal records to the account management system 130. In an example embodiment, the data storage unit 129 can include any local or remote data storage structure accessible to the merchant device 120 suitable for storing information. In an example embodiment, the data storage unit 129 stores encrypted information, such as HTML5 local storage.

According to an example embodiment, the merchant device 120 may connect to network 140 via a wired connection. For example, the connection may be a wired universal serial bus (USB) or Ethernet connection. In another example embodiment, the merchant device 120 may connect to the network via a wireless connection. For example, the connection may be a Wi-Fi or Bluetooth connection to a hotspot that has a wired/wireless Internet connection (for example, MiFi), or any other wired or wireless connection suitable for communicating signals with network 140. In another example embodiment, the connection may be a cellular network connection.

In an example embodiment, the merchant device 120 functions as a point of sale (POS) terminal and is capable of processing a purchase transaction initiated by a user of a user device 110. In an example embodiment, the user requests a purchase from the merchant device 120. The merchant device 120 receives or otherwise reads payment account information from the user device 110. In an example embodiment, the purchase is initiated by a wireless “tap” of the user device 110 with the merchant device 120.

The merchant device 120 communicates with the user device 110 via an antenna 127. In an example embodiment, once the merchant device application 125 has been activated and prioritized, the controller 126 is notified of the state of readiness of the merchant device 120 for a transaction. The controller 126 outputs through the antenna 127 a radio signal, or listens for radio signals from the user device 110. On establishing a secure communication channel between the merchant device 120 and the user device 110, the merchant device 120 may request a list of applications 115 available from the user device 110. A directory is first displayed, after which, based on the set priority or the type of user device 110, an application 115 is chosen and initiated for the transaction.

An example user device 110 can refer to a smart communication device that can communicate via an electronic, magnetic or radio frequency field between the user device 110 and another device, such as a merchant device 120 using an antenna 117. In an example embodiment, the user device 110 has processing capabilities, such as storage capacity/memory and one or more applications 115 that can perform a particular function. In an example embodiment, the user device 110 contains an operating system (not illustrated) and user interface 111. Example user device 110 comprise smart phones, mobile phones, personal digital assistants (PDAs), mobile computing devices (for example, netbooks, tablets, and iPads), laptops, wearable computing devices (for example, watches, rings, or glasses), and other devices, in each case having processing and user interface functionality.

The user can use the user device 110 to perform an offline payment transaction via a user interface 111 and the application 115. The application 115 is a program, function, routine, applet or similar entity that exists on and performs its operations on the user device 110. For example, the application 115 may be one or more of a shopping application, merchant device 120 application, a payment application, a digital wallet application, a loyalty card application, another value-added application, a user interface 111 application, or other suitable application operating on the user device 110. In some embodiments, the user must install an application 115 and/or make a feature selection on the user device 110 to obtain the benefits of the techniques described herein. Additionally, the user device 110 may comprise a secure element (not illustrated), which can exist within a removable smart chip or a secure digital (SD) card, which can be embedded within a fixed chip on the device 110, or be realized as a secure compartment of a security-enhanced operating system. In certain example embodiments, Subscribed Identity Module (SIM) cards may be capable of hosting a secure element, for example, an NFC SIM Card. The secure element allows a software application 115 resident on the user device 110 and accessible by the device user to interact securely with certain functions within the secure element, while protecting information stored within the secure element. The secure element may comprise one or more applications 115 running thereon that perform the functionality described herein.

In an example embodiment, the controller 116 is a Bluetooth link controller. The Bluetooth link controller 116 may be capable of sending and receiving data, identifying the merchant device 120, performing authentication and ciphering functions, and directing how the user device 110 will listen for transmissions from the merchant device or configure the user device 110 into various power-save modes according to the Bluetooth-specified procedures. In another example embodiment, the controller 116 is a Wi-Fi controller or an NFC controller capable of performing similar functions.

An example user device 110 comprises one or more keys and/or certificates. In an example embodiment, the user device 110 generates a withdrawal record for an amount indicated on the payment request received from the merchant device 120. The user device 110 signs the withdrawal record with an account certificate private key 112 and transmits the signed withdrawal record with the balance certificate 113 to the merchant device 120.

In an example embodiment, the data storage unit 119 may be implemented in a secure element or other secure memory (not shown) on the user device 110 or may be a separate memory unit resident on the user device 110. An example data storage unit 119 enables storage of signed withdrawal records until the user device 110 has network 140 access and can communicate the signed withdrawal records to the account management system 130. In an example embodiment, the data storage unit 119 can include any local or remote data storage structure accessible to the user device 110 suitable for storing information. In an example embodiment, the data storage unit 119 stores encrypted information, such as HTML5 local storage.

According to an example embodiment, the user device 110 may connect to network 140 via a wired connection. For example, the connection may be a wired universal serial bus (USB) or Ethernet connection. In another example embodiment, the user device 110 may connect to the network via a wireless connection. For example, the connection may be a Wi-Fi or Bluetooth connection to a hotspot that has a wired/wireless Internet connection (for example, MiFi), or any other wired or wireless connection suitable for communicating signals with network 140. In another example embodiment, the connection may be a cellular network connection.

An example user device 110 and merchant device 120 communicate with the account management system 130. An example account management system 130 comprises an account management module 131 and a data storage unit 137. An example account management module 131 maintains an account for the user. In an example embodiment, the account comprises information for one or more financial accounts maintained by one or more financial institutions. In an example embodiment, the financial account information is saved in the data storage unit 137.

In an example embodiment, the account management system 130 stores the user's financial transactions made using the user's account management system 130 account. For example, each deposit of funds and each withdrawal of funds for each account in the data storage unit 137. In an example embodiment, the account management system 130 analyzes the transaction history to identify missing data or possible errors.

An example account management system 130 comprises one or more keys and/or certificates. In an example embodiment, the account management system 130 comprises the account certificate public key 112a and can verify the identity of the user device 110 and/or user's account management system 130 account using the account certificate public key 112a. In an example embodiment, the account management system 130 accesses the user's account management system 130 account and creates the balance certificate 113. The account management system 130 signs the balance certificate 113 with a balance certificate private key 113 and transmits the balance certificate 113 to the user device 110. In an example embodiment, the merchant device 120 comprises the balance certificate public key 113a and confirms that the balance certificate 113 was signed by the account management system 130 as part of the verification process.

In an example embodiment, the account management system 130 also comprises a merchant device signing certificate public key 124a. The account management system 130 verifies the withdrawal record signed by the merchant device signing certificate 124 using the merchant device signing certificate public key 124a to confirm the identity of the merchant device 120.

In an example embodiment, the account management system 130 accesses the user's account management system 130 account and saves the signed withdrawal records in the data storage unit 137. The data storage unit 137 can include any local or remote data storage structure accessible to the account management system 130 suitable for storing information. In an example embodiment, the data storage unit 137 stores encrypted information, such as HTML5 local storage.

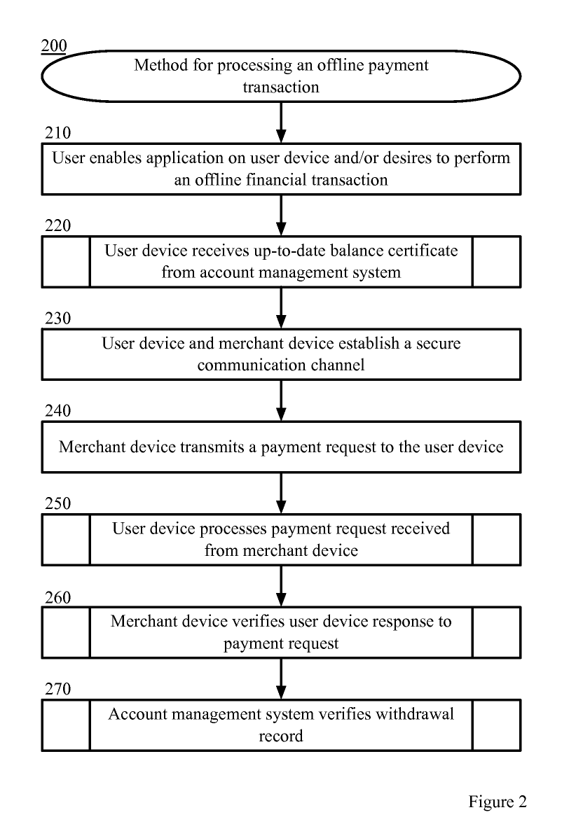

The components of the example operating environment 100 are described hereinafter with reference to the example methods illustrated in FIGS. 2-8. The example methods of FIGS. 2-8 may also be performed with other systems and in other environments.

### Example System Processes

FIG. 2 is a block flow diagram depicting a method 200 for processing an offline payment transaction, in accordance with certain example embodiments. The method 200 is described with reference to the components illustrated in FIG. 1.

In block 210, the user enables an application 115 on the user device 110 and/or indicates a desire to perform an offline financial transaction. In an example embodiment, the user enables the application 115 to allow the user device 110 to communicate with the account management system 130 and perform an offline payment transaction with the merchant device 120.

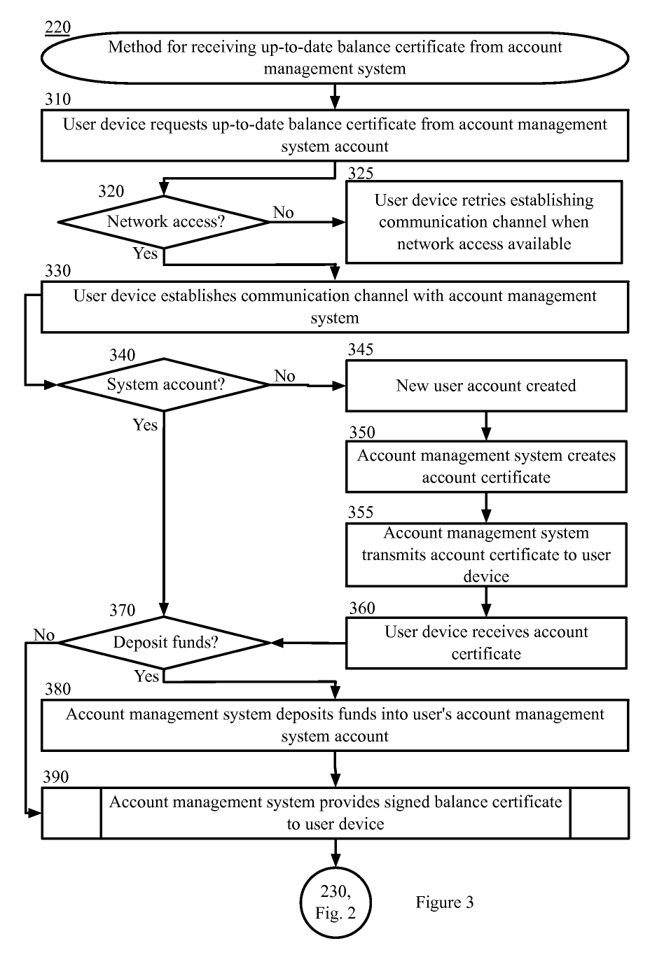

In block 220, user device 110 receives an up-to-date balance certificate from the account management system 130. The method 220 for receiving the up-to-date balance certificate from the account management system 130 is described in more detail hereinafter with reference to the methods described in FIG. 3.

FIG. 3 is a block flow diagram depicting a method 220 for receiving an up-to-date balance certificate from an account management system 130, in accordance with certain example embodiments, as referenced in block 220. The method 220 is described with reference to the components illustrated in FIG. 1.

In block 310, the user device 110 requests an up-to-date balance certificate 113 from the account management system 130. In an example embodiment, the request comprises an authorization to deposit of fund to the user's account management system 130 account. In an example embodiment, the user authorizes the deposit by authorizing a transfer of funds from a financial account to the user's account management system 130 account. In another example embodiment, the user device 110 requests a lock of available funds. In yet another example embodiment, the user device 110 requests an unlock of available funds. In an example embodiment, an up-to-date balance certificate 113 is requested during any communication between the user device 110 and the account management system 130.

In block 320, the user device 120 receives the request and determines whether the user device 120 has network 140 access. In an example embodiment, network 140 access is required to communicate with the account management system 130. In an example embodiment, the user device 120 determines whether there is network 140 access by trying to establish a communication channel with the account management system 130.

If the user device 120 does not have network 140 access, the method 220 proceeds to block 325. In block 325, the user device 120 retries establishing a communication channel with the account management system 130 when the device 120 has network 140 access.

Returning to block 320 in FIG. 3, if the user device 120 has network 140 access, the method 220 proceeds to block 330. In block 330, the user device 120 establishes a communication channel with the account management system 130. In an example embodiment, the communication channel is established via the network 140.

In block 340, the account management system 130 determines whether the user has an account maintained by, or accessible to, the account management system 130. In an example embodiment, the account management system 130 receives notification that the user has enabled the application 115 on the user devices 110 and determines whether the user has an account management system 130 account. In an example embodiment, the user is prompted to log into or create an account management system 130 account when the application 115 is enabled. In another example embodiment, the user previously logged into the account management system 130 account and is otherwise automatically logged into the account. In yet another example embodiment, the user's login credentials are shared across other accounts (for example, social networking websites and user device 120 accounts) and the user is automatically logged into the account management system 130 account using the shared login credentials.

If the user does not have an account management system 130 account, the method 220 proceeds to block 345 in FIG. 3. In block 345, the user is prompted to create an account management system 130 account. In an example embodiment, the user is prompted to register with the account management system 130 when the user enables the application 115. In another example embodiment, the user may create the account management system 130 account at any time prior to, after, or while enabling the application 115. In an example embodiment, the user accesses the account management system 130 via the application 115 and the network 140. In an example embodiment, the user submits registration information to the account management system 130, including, but not limited to, name, address, phone number, e-mail address, and information for one or more registered financial card accounts, including bank account debit cards, credit cards, a loyalty rewards account card, or other type of account that can be used to make a purchase (for example, card type, card number, expiration date, security code, and billing address). In an example embodiment, the user's account management system 130 account information is saved in the data storage unit 137 and is accessible to the account management module 131. In an example embodiment, the account management system 130 account is a digital wallet account maintained by the account management system 130 or a third party system. In another example embodiment, the user may use a website to register with the account management system 130.

In another example embodiment, the user is not required to log in or register for the account management system 130 account. In this embodiment, the methods described herein are performed for a “guest” user.

In block 350, the account management system 130 creates an account certificate. In an example embodiment, the account certificate 112 comprises an identity of the user and/or user device 110 that corresponds to the user's account management system 130 account. The account certificate 112 is maintained by the user device 110 and/or account management system 130. In an example embodiment, the account certificate 112 functions to sign a withdrawal record created by the user device 110 in response to an offline payment request received from a merchant device 120.

In an example embodiment, the account certificate 112 comprises an account certificate public key 112a. The account certificate public key 112a functions to verify the authenticity of the withdrawal record signed by the account certificate 112. In an example embodiment, the account certificate public key 112a is maintained by the merchant device 120 and/or the account management system 130. In an example embodiment, the account certificate public key 112a is transmitted by the account management system 130 to the merchant device 120 when the merchant device 120 is registered or at any time thereafter.

In block 355 the account management system 130 transmits the account certificate 112 to the user device 110. In an example embodiment, any communication between the user device 110 and the account management system 130 is signed by the account certificate 112. In this embodiment, the account management system 130 identifies the user's account management system 130 account by reading the signature.

In block 360, the user device 110 receives the account certificate 112.

In block 370, the account management system 130 determines whether the request for an up-to-date balance certificate 113 comprises an authorization to deposit of fund to the user's account management system 130 account. In an example embodiment, the user authorizes the deposit by authorizing a transfer of funds from a financial account to the user's account management system 130 account. In an example embodiment, the user performs the authorization using the user device 110. For example, the user accesses the application 115 to requests a deposit of funds. In another example embodiment, the user performs the authorization using another computing device or a third party system that can communicate with the account management system 130. In this example embodiment, the user device 120 will request an up-to-date balance certificate at a time when the device 120 has network access.

If the request for an up-to-date balance certificate 113 comprises a request to deposit funds, the method 220 proceeds to block 380 in FIG. 3. In block 380, the account management system 130 processed the deposit of funds into the user's account. In an example embodiment, funds are electronically transferred from a financial account to the user's account management system 130 account.

The method 220 then proceeds to block 390 in FIG. 3.

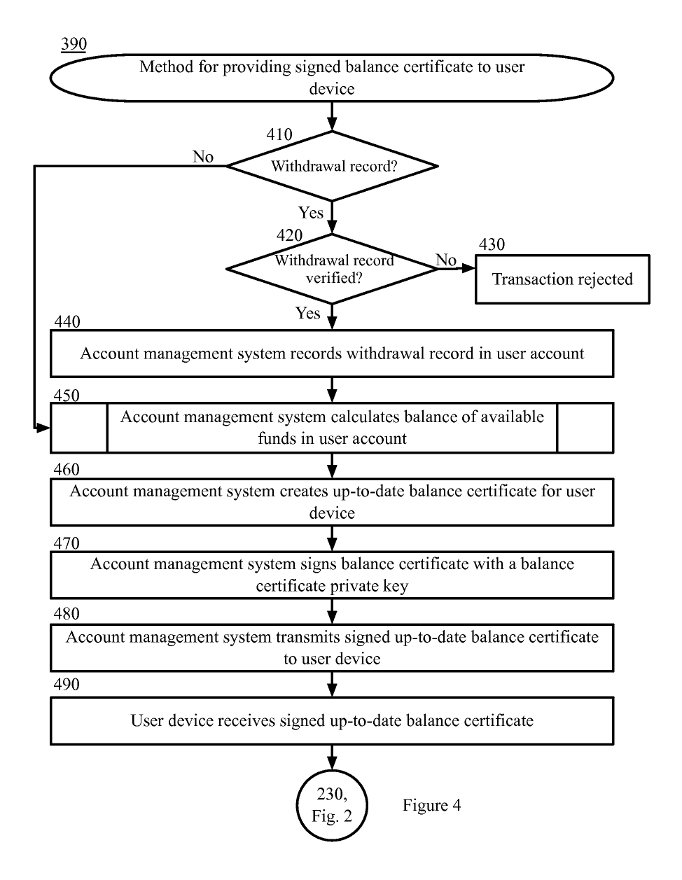

Returning to block 370 in FIG. 3, if the request for an up-to-date balance certificate 113 does not comprise a request to deposit funds, the method 220 proceeds to block 390 in FIG. 3. In block 390, the account management system 130 provides a signed balance certificate 113 to the user device 110. The method 390 for providing a signed balance certificate 113 to the user device 110 is described in more detail hereinafter with reference to the methods described in FIG. 4.

FIG. 4 is a block flow diagram depicting a method 390 for providing a signed balance certificate 113 to the user device 110, in accordance with certain example embodiments, as referenced in block 390. The method 390 is described with reference to the components illustrated in FIG. 1.

In block 410, the account management system 130 determines whether the request for an up-to-date balance certificate 113 comprises a withdrawal record. In an example embodiment, the user device 110 transmits one or more withdrawal records to the account management system 130 with the request for an up-to-date balance certificate 113. In an example embodiment, the user device 110 transmits all withdrawal records to the account management system. In this embodiment, the user device 110 determines which withdrawal records have not yet been sent and transmits those records to the account management system 130. In an example embodiment, each withdrawal record comprises an identification of an offline payment transaction that took place with a merchant device 120. The account management system 130 saves each withdrawal record in the user's account management system 130 account and uses the records to determine an available balance of funds.

If the request for an up-to-date balance certificate 113 comprises a withdrawal record, the method 390 proceeds to block 420 in FIG. 4. In block 420, the account management system 130 verifies the withdrawal record. In an example embodiment, each withdrawal record is signed by a merchant device 120 during the offline payment transaction. In an example embodiment, the merchant device 120 signs the withdrawal record using the merchant device signing certificate 124. In an example embodiment, the withdrawal record is signed by the merchant device signing certificate 124 to authenticate the record. In this embodiment, the account management system 130 can verify the withdrawal record using the merchant device signing certificate public key 124a. In an example embodiment, the signed withdrawal record verifies that the offline payment transaction occurred between the user device 110 and the merchant device 120.

If the withdrawal record is not verified, the method 390 proceeds to block 430 in FIG. 4. In block 430, the transaction is rejected and the account management system 130 transmits a notice to the user device 120.

Returning to block 420 in FIG. 4, if the withdrawal record is verified, the method 390 proceeds to block 440 in FIG. 4. In block 440, the account management system 130 records the withdrawal record in the user's account management system 130 account. In an example embodiment, the account management system 130 updates the user's account to note the offline payment transaction.

The method 390 then proceeds to block 450 in FIG. 4.

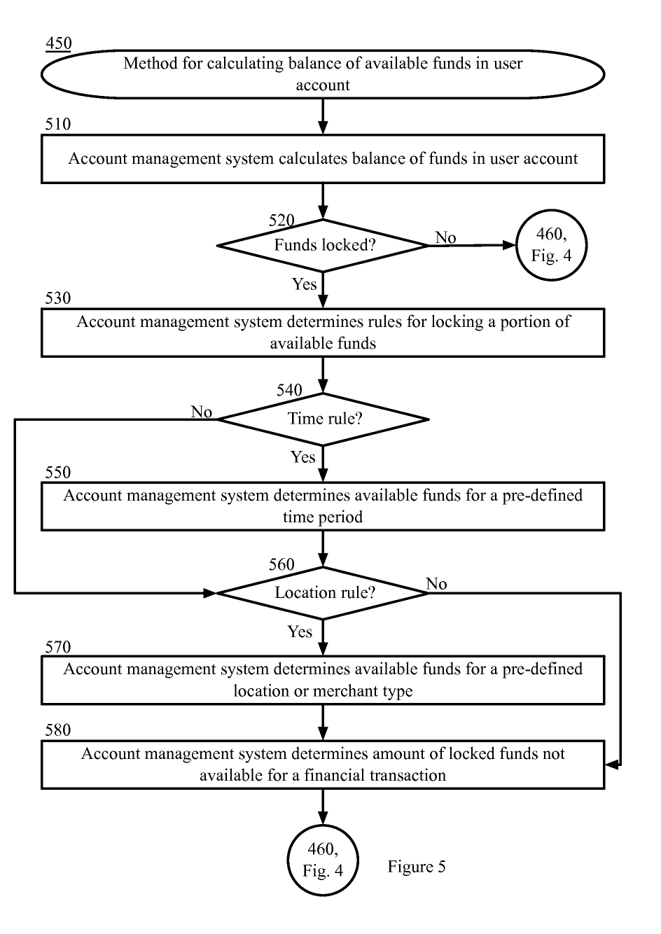

Returning to block 410 in FIG. 4, if the request for an up-to-date balance certificate does not comprise a withdrawal record, the method 390 proceeds to block 450 in FIG. 4. In block 450, the account management system 130 calculates a balance of available funds in the user's account management system 130 account. The method 450 for calculating a balance of available funds in the user's account management system 130 account is described in more detail hereinafter with reference to the methods described in FIG. 5.

FIG. 5 is a block flow diagram depicting a method 450 for calculating a balance of available funds in the user's account management system 130 account, in accordance with certain example embodiments, as referenced in block 450. The method 450 is described with reference to the components illustrated in FIG. 1.

In block 510, the account management system 130 calculates a balance of funds in the user's account management system 130 account. In an example embodiment, the account management system 130 calculates a difference between the total amount of deposits and the total amount of the withdrawal records. In another example embodiment, the account management system 130 maintains a running total of the balance of funds in the user's account.

In block 520, the account management system 130 determines whether a portion of the balance of funds is locked. In an example embodiment, the user transmits a request to lock a portion of the balance of funds with the request for an up-to-date balance certificate 113. In another example embodiment, the account management system 130 maintains rules or logic understood without human intervention that determine an amount of the locked funds. In yet another example embodiment, the user defines the rules for determining the amount of locked funds. For example, a rule may require a $25 minimum balance is maintained in the user's account management system 130 account. In this example, the account management system 130 would lock $25 to prevent this minimum amount from being available for an offline payment. In another example, a rule may require that 5% of the funds available in the user's account management system 130 account are locked. In this example, if the user had $100 in the user's account, the account management system 130 would lock $5 to prevent this minimum amount from being available for an offline payment.

If no portion of the balance of funds are locked, the method 450 proceeds to block 450 in FIG. 4.

Returning to block 520, if a portion of the balance of funds are locked, the method 450 proceeds to block 530 in FIG. 5. In block 530, the account management system 130 determines the rules for locking or unlocking a portion of the balance of funds. In an example embodiment, the rules are defined by the user, the account management system, a third party, or any combination thereof. In an example embodiment, the rules are defined when the user's account management system 130 account is established. In another example embodiment, the rules are established and are subject to change at any time after being established. In yet another example embodiment, the user's request for an up-to-date balance certificate 113 comprises one or more rules for locking or unlocking funds.

In an example embodiment, all the funds in the user's account management system 130 account are locked and the account management system 130 determines whether a portion of the balance of funds may be unlocked based on the rules. For example, the account management system 130 determines that 50% of the balance of funds can be made available for an offline payment transaction by applying one or more rules.

In block 540, the account management system 130 determines whether there is a time-based rule for locking or unlocking a portion of the balance of funds. In an example embodiment, a portion of the balance of funds is available for a limited time. For example, a portion of the balance of funds may be unlocked for a single transaction. In this example, the balance certificate 113 is valid for only a single transaction or for only a short amount of time (for example, long enough to only complete one offline transaction). After a single offline payment transaction is completed, or after the expiration of the time available for the balance certificate 113, the user is required to request a new up-to-date balance certificate 113.

In another example, a portion of the available funds may be locked for a period of time. For example, a portion of balance of funds is locked for five minutes. In this example, the user can complete an offline payment transaction during those five minutes with an amount of available funds up to the locked amount. After the transaction is completed, the lock is removed. The user can extend the locking time before those five minutes expire by requesting a new balance certificate 113.

If the account management system 130 determines there is a time-based rule for locking or unlocking a portion of the balance of funds, the method 450 proceeds to block 550 in FIG. 5. In block 550, the account management system 130 determines the available funds for the pre-defined time period.

The method 450 then proceeds to block 560 in FIG. 5.

Returning to block 540 in FIG. 5, if the account management system 130 determines there is not a time-based rule for locking or unlocking a portion of the balance of funds, the method 450 proceeds to block 560 in FIG. 5. In block 560, the account management system 130 determines whether there is a location-based rule for locking or unlocking a portion of the balance of funds. In an example embodiment, funds are only available for use in a specified location or for an offline payment transaction with a specified type of merchant. For example, the user only wishes to use funds for mass transit, at restaurants, or in City X. In another example embodiment, funds are only available for use within a predefined proximity of a first offline payment transaction or other geographic location. For example, once the user initiates an offline payment transaction a Merchant X, the user can only complete additional transactions within a 10 foot radius of the location of Merchant X. In an example embodiment, each user may have more than one user device 110. In this embodiment, each user device 110 can have a different balance certificate. By locking a portion of the balance of funds according to location, the user cannot use more than one user device 110 to over spend the user's balance of funds.

If the account management system 130 determines there is a location-based rule for locking or unlocking a portion of the balance of funds, the method 450 proceeds to block 570 in FIG. 5. In block 570, the account management system 130 determines the available funds for the pre-defined location or merchant type.

The method 450 then proceeds to block 580 in FIG. 5.

Returning to block 560 in FIG. 5, if the account management system 130 determines there is not a location-based rule for locking or unlocking a portion of the balance of funds, the method 450 proceeds to block 580 in FIG. 5. In block 580, account management system 130 determines an amount of locked funds not available for an offline payment transaction and an amount of funds available for an offline payment transaction based on the one or more rules for locking funds. In an example embodiment, the amount of available funds comprises a difference between the total amount of deposits and the total amount of the withdrawal records minus any locked funds.

The method 450 then proceeds to block 460 in FIG. 4.

Returning to FIG. 4, in block 460, the account management system 130 creates an up-to-date balance certificate 113 for the user device 110. In an example embodiment, the up-to-date balance certificate 113 comprises the amount of funds available for an offline payment transaction. In an example embodiment, the balance certificate 113 is limited in time. In this example embodiment, the balance certificate 113 expires after a pre-defined amount of time passes. In another example embodiment, the balance certificate 113 is limited in a number of offline purchase transactions. In this example embodiment, the balance certificate 113 expires after the pre-defined number of offline purchase transaction are completed. In another example embodiment, the balance certificate 113 is limited by time, number of transactions, geographic location, type of merchant, or any other limiting rule established by the account management system 130 or the user. In an example embodiment, the balance certificate comprises one or more rules limiting the amount of funds available for the payment transaction.

In block 470, the account management system 130 signs the balance certificate 113. In an example embodiment, the merchant device 120 can read the signed balance certificate 113 using the balance certificate public key 113a to verify the authenticity of the signed balance certificate 113.

In block 480, the account management system 130 transmits the signed balance certificate 113 to the user device 110. In an example embodiment, the signed balance certificate 113 is transmitted via the network 140 connection to the user device 110.

In block 490, the user device 110 receives the signed balance certificate 113.

The method 390 then proceeds to block 230 in FIG. 2.

Returning to FIG. 2, in block 230, the user device 110 and merchant device 120 establish a communication channel. In an example embodiment, the user has indicated a desire to complete an offline payment transaction with the merchant. In an example embodiment, the user accesses an application 115 on the user device 110 that enables the user device 110 to perform an offline payment transaction. In an example embodiment, the user accesses an application 115 that enables the user device 110 to wirelessly communicate with the merchant device 120. In this embodiment, the devices (including devices 110 and 120) communicate via a secure communication channel (for example, near field communications, Bluetooth, Wi-Fi, or other form of wireless communication channel).

In block 240 the merchant device 120 transmits a payment request to the user device 110. In an example embodiment, the merchant enters a payment request amount into an application 125 on the merchant device 120. In this embodiment, the payment request comprises an identification of the merchant device 120, a payment request amount, and/or a timestamp. In an example embodiment, the payment request is transmitted via the secure communication channel.

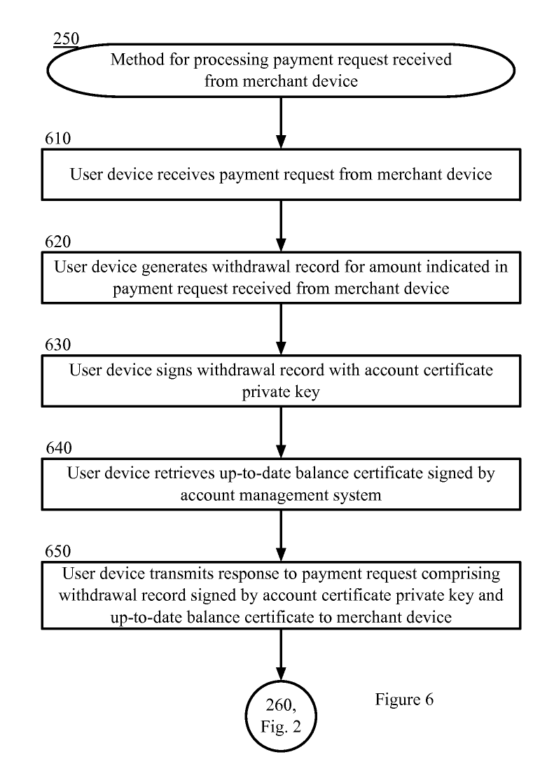

In block 250, the user device 110 processes the payment request received from the merchant device 120. The method 250 for processing a payment request received from a merchant device 120 is described in more detail hereinafter with reference to the methods described in FIG. 6.

FIG. 6 is a block flow diagram depicting a method 250 for processing a payment request received from a merchant device 120, in accordance with certain example embodiments, as referenced in block 250. The method 250 is described with reference to the components illustrated in FIG. 1.

In block 610, the user device 110 receives the payment request from the merchant device 120.

In block 620, the user device 110 generates a withdrawal record for an amount indicated on the payment request received from the merchant device 120. In an example embodiment, the withdrawal record comprises information received in the payment request (for example, an identification of the merchant or merchant device 120, a payment request amount, and a timestamp). In another example embodiment, the withdrawal record comprises an identification of the user device 110, an identification of the user, and/or an identification of the user's account management system 130 account. In another example embodiment, the user may change the payment request amount using the application 115 prior to or while the withdrawal record is created.

In block 630, the user device 110 signs the withdrawal record. In an example embodiment, the withdrawal record is signed with the account certificate 112 private key. In an example embodiment, withdrawal record is signed by the user device 110 or application 115 to allow the merchant device 120 to verify that the account information (for example, the account management system 130 account) belongs to the user and is authorized for use in the offline payment transaction.

In block 640, the user device 110 retrieves the up-to-date balance certificate 113 signed by the account management system 130. In an example embodiment, the balance certificate 113 is retrieved at any time after the payment request is received from the merchant device 120. In an example embodiment, the user device 120 confirms the availability of funds for the offline payment transaction by cross-referencing the payment request amount with the amount of funds available for an offline payment transaction disclosed by the balance certificate 113. In another example embodiment, the user device 110 reviewed any rules or limitations placed on the amount of funds available for an offline payment transaction and determines if the payment transaction meets those rules.

In block 650, the user device 110 transmits a response to the payment request to the merchant device 120. In an example embodiment, the response comprises the signed withdrawal record and the signed balance certificate 113. In an example embodiment, the response to the payment request is transmitted via the secure communication channel between the user device 110 and the merchant device 120.

The method 250 then proceeds to block 260 in FIG. 2.

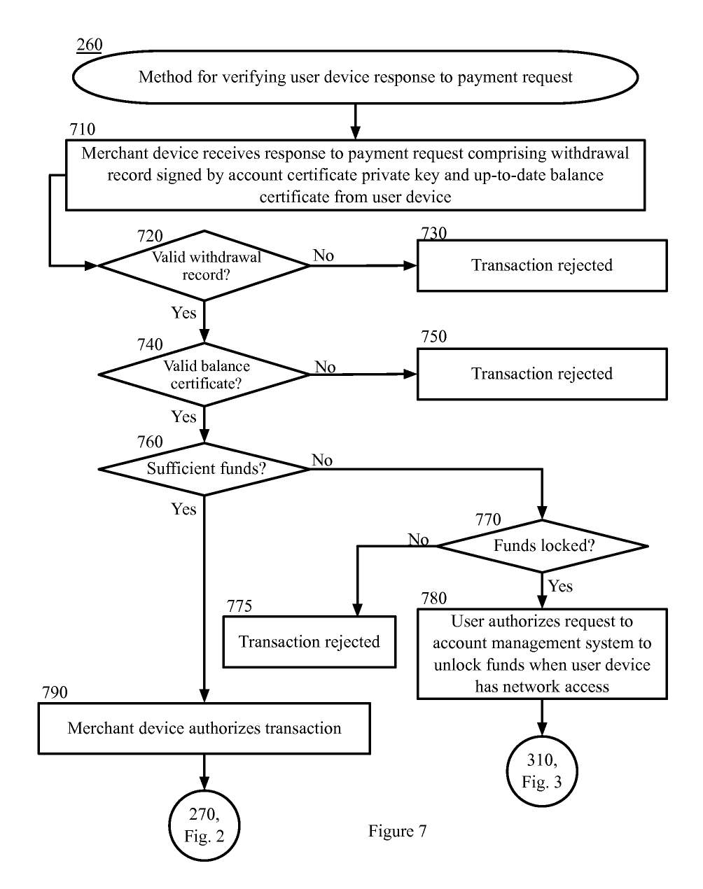

Returning to FIG. 2, in block 260, the merchant device 120 verifies the response to the payment request received from the user device 110. The method 260 for verifying the response to the payment request received from the user device 110 is described in more detail hereinafter with reference to the methods described in FIG. 7.

FIG. 7 is a block flow diagram depicting a method 260 for verifying the response to the payment request received from the user device 110, in accordance with certain example embodiments, as referenced in block 260. The method 260 is described with reference to the components illustrated in FIG. 1.

In block 710, the merchant device 120 receives the response to the payment request from the user device 110. In an example embodiment, the response comprises the signed withdrawal record and the signed balance certificate 113.

In block 720, the merchant device 120 verifies the withdrawal record. In an example embodiment, the merchant device 120 verifies the signed withdrawal record using an account certificate public key 112a. In this embodiment, the withdrawal record was signed by the account certificate 112 on the user device 110 prior to transmission to the merchant device 120. The merchant device 120 verifies the signature on withdrawal record to confirm the identity of the user device 110, the user, and/or the user's account management system 130 account.

If the withdrawal record is not verified, the method 260 proceeds to block 730 in FIG. 7. In block 730, the offline payment transaction is rejected. In an example embodiment, the merchant device 120 transmits a notification of the rejected transaction to the user device 110.

Returning to block 720 in FIG. 7, if the withdrawal record is verified, the method 260 proceeds to block 740 in FIG. 7. In block 740, the merchant device 120 verifies the balance certificate 113. In an example embodiment, the merchant device 120 verifies the signed balance certificate 113 using a balance certificate public key 113a.

In this embodiment, the balance certificate 113 was signed by the account management system 130 prior to transmission to the user device 110. The signed balance certificate 113 was transmitted to the merchant device 120 with the withdrawal record in response to the payment request. The merchant device 120 verifies the signature on the balance certificate 113 to confirm the availability of the funds to complete the offline payment transaction. In an example embodiment, the merchant device 120 verifies that the balance certificate 113 is not expired and/or that any other limitations placed on the balance certificate (for example, geographic limitations, merchant limitations, or other functional limitations) are met.

If the balance certificate 113 is not verified, the method 260 proceeds to block 750 in FIG. 7. In block 750, the offline payment transaction is rejected. In an example embodiment, the merchant device 120 transmits a notification of the rejected transaction to the user device 110.

Returning to block 740 in FIG. 7, if the balance certificate 113 is verified, the method 260 proceeds to block 760 in FIG. 7. In block 760, the merchant device 120 verifies the availability of funds to complete the offline payment transaction. In an example embodiment, the merchant device 120 reads the available funds from the balance certificate 113. In an example embodiment, the merchant device 120 verifies the offline payment transaction complies with any rules placed on the available funds.

If sufficient funds are not available for the offline payment transaction, the method 260 proceeds to block 770 in FIG. 7. In block 770, the merchant device 120 and/or user device 110 determine whether a portion of the balance of funds are locked or otherwise unavailable for use during the offline payment transaction. In an example embodiment, the balance certificate 113 comprises a notation that a portion of the funds are locked.

If a portion of the balance of funds are not locked, the method 260 proceeds to block 775 in FIG. 7. In block 775, the offline payment transaction is rejected. In an example embodiment, the merchant device 120 transmits a notification of the rejected transaction to the user device 110.

Returning to block 770 in FIG. 7, if a portion of the balance of funds are locked or otherwise unavailable for use during the offline payment transaction, the method 260 proceeds to block 780 in FIG. 7. In block 780, the user authorizes a request to the account management system 130 to unlock a portion of the funds. In an example embodiment, a request to unlock funds is transmitted to the account management system 130 only when the user device 110 has a network 140 connection. In this embodiment, the transaction is rejected until additional funds are unlocked.

The method 260 then proceeds to block 310 in FIG. 3 and the user device 110 requests a new balance certificate 113 with the unlocked funds.

Returning to block 760 in FIG. 7, if sufficient funds are available for the offline payment transaction, the method 260 proceeds to block 790 in FIG. 7. In block 790, the merchant device 120 authorizes the offline payment transaction.

The method 260 then proceeds to block 270 in FIG. 2.

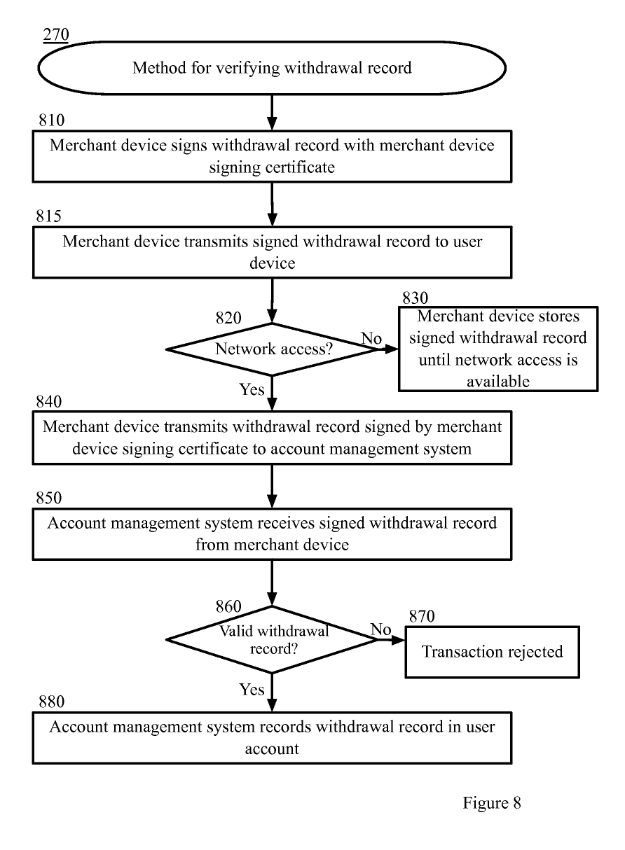

Returning to FIG. 2, in block 270, the account management system 130 verifies the withdrawal record. The method 270 for verifying the withdrawal record is described in more detail hereinafter with reference to the methods described in FIG. 8.

FIG. 8 is a block flow diagram depicting a method 270 for verifying the withdrawal record, in accordance with certain example embodiments, as referenced in block 270. The method 270 is described with reference to the components illustrated in FIG. 1.

In block 810, the merchant device 120 signs the withdrawal record with the merchant device signing certificate 124. In an example embodiment, the merchant device 120 authorized the offline payment transaction after it verified the withdrawal record, verified the balance certificate 113, and determined that there are sufficient funds for the offline payment transaction. In this embodiment, the merchant device 120 signs the withdrawal record to authorize the transaction. In another example embodiment, the merchant device 120 creates a status code or message that indicates to the user device 110 that the transaction was successful.

In block 815, the merchant device 120 transmits the signed withdrawal record to the user device 110. In an example embodiment, the signed withdrawal record is transmitted via the secure communication channel between the user device 110 and the merchant device 120. In an example embodiment, transmission of the signed withdrawal record to the user device 110 completes the offline payment transaction. In another example embodiment, the merchant device 120 transmits a status code or message to the user device 110 indicating that the transaction was successful.

In block 820, the merchant device 120 determines whether it has network 140 access. In an example embodiment, the merchant device 120 requires network 140 access to communicate with the account management system 130.

If the merchant device 120 does not have network 140 access, the method 270 proceeds to block 830 in FIG. 8. In block 830, the merchant device 120 stores the withdrawal record until it has network 140 access.

Returning to block 820 in FIG. 8, if the merchant device 120 has network 140 access, or once network 140 access is available, the method 270 proceeds to block 840 in FIG. 8. In block 840, the merchant device 120 transmits the withdrawal record to the account management system 130. In an example embodiment, the withdrawal record is signed by the merchant device signing certificate 124. In another example embodiment, the withdrawal record is the same withdrawal record received from the user device 110 in response to the payment request.

In block 850, the account management system 130 receives the withdrawal record from the merchant device 120.

In block 860, the account management system 130 verifies the withdrawal record. In an example embodiment, the account management system 130 verifies the withdrawal record using the merchant device signing certificate public key 124a. In this embodiment, the account management system 130 verifies the identity or validity of the withdrawal record and/or the merchant device 120. In another example embodiment, the merchant device 120 transmits an identifier or message with the withdrawal record. In this embodiment, the account management system 130 verifies the withdrawal record by confirming the identity of the merchant device 120. In another example embodiment, the account management system 130 verifies the withdrawal record by verifying the identity of the user or user device 110.

If the withdrawal record verification fails, the method 270 proceeds to block 870 in FIG. 8. In block 870, the offline payment transaction is rejected. In an example embodiment, the account management system 130 transmits a notification of the rejected transaction to the merchant device 120.

Returning to block 860 in FIG. 8, if the withdrawal record verification passes, the method 270 proceeds to block 880 in FIG. 8. In block 880, the account management system 130 records the withdrawal record in the user's account management system 130 account. In an example embodiment, the withdrawal record comprises an identification of the user, user device 110, and/or user's account management system 130 account. In this embodiment, the account management system 130 updates the user's account with the withdrawal record received from the merchant device 120.

In an example embodiment, the user device 110 requests a new balance certificate 113 prior to or after the merchant device 120 transmits the withdrawal record to the account management system 130. In this embodiment, the user device 110 transmits the signed withdrawal record to the account management system 130. The account management system 130 records the two withdrawal records received for the same offline payment transaction in the user's account management system 130 account. In an example embodiment, the two withdrawal records are used to verify the validity of the balance of funds in the user's account.

### Other Example Embodiments

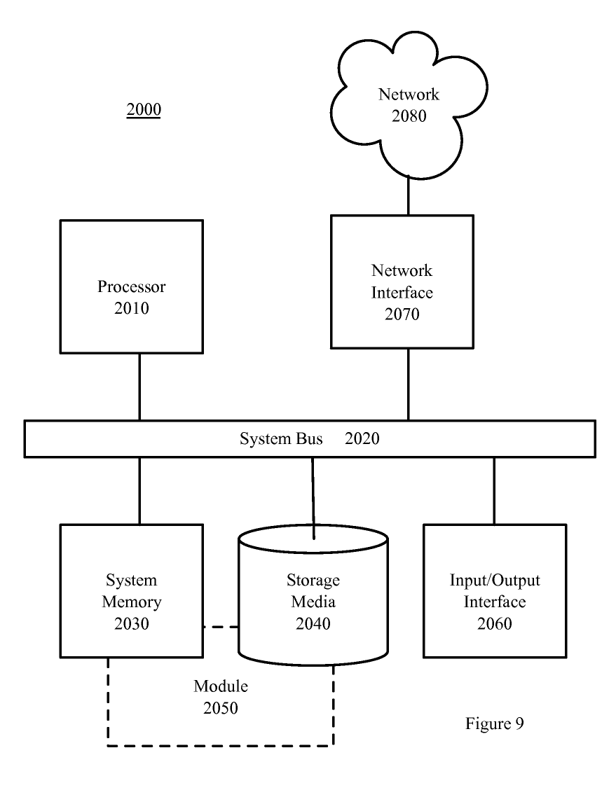

FIG. 9 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (DSP), an application specific integrated circuit (ASIC), a graphics processing unit (GPU), a field programmable gate array (FPGA), a programmable logic device (PLD), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (ROM), programmable read-only memory (PROM), erasable programmable read-only memory (EPROM), flash memory, or any other device capable of storing program instructions or data with or without applied power. The system memory 2030 may also include volatile memories such as random access memory (RAM), static random access memory (SRAM), dynamic random access memory (DRAM), and synchronous dynamic random access memory (SDRAM). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (CD-ROM), a digital versatile disc (DVD), a Blu-ray disc, a magnetic tape, a flash memory, other non-volatile memory device, a solid state drive (SSD), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (I/O) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (SCSI), serial-attached SCSI (SAS), fiber channel, peripheral component interconnect (PCI), PCI express (PCIe), serial bus, parallel bus, advanced technology attached (ATA), serial ATA (SATA), universal serial bus (USB), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (SOC), system on package (SOP), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments as defined in the claims, the scope of which is to be accorded the broadest interpretation so as to encompass such alternatives.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for locking funds available for secure offline payments, comprising:
receiving, by one or more computing devices and from a user mobile computing device, a request for a balance certificate indicating an amount of funds available for use in an offline payment transaction that will be completed without network access, the request comprising an account management system account identifier;
determining, by the one or more computing devices, that a portion of the available funds are locked from use during an offline payment transaction;
creating, by the one or more computing devices, the balance certificate, the balance certificate indicating the amount of funds available for use in the offline payment transaction minus the portion of the available funds are locked from use during the offline payment transaction;
transmitting, by the one or more computing device, the balance certificate to the user mobile communication device; and
receiving, by the one or more computing devices and from a merchant mobile communication device, a withdrawal record for an offline payment transaction between the merchant mobile communication device and the user mobile communication device,
wherein the balance certificate were transmitted by the user mobile communication device to the merchant mobile communication device in response to a payment request for the offline payment transaction, and
wherein the merchant mobile communication device determined that sufficient funds are available for the offline payment transaction by reading the balance certificate; and
updating, by the one or more computing devices, the amount of funds available for use in a second offline payment transaction.

2. The method of claim 1, wherein the portion of the available funds are locked from use during an offline payment transaction for a pre-defined time period.

3. The method of claim 1, wherein the portion of the available funds are locked from use during an offline payment transaction for a specified location.

4. The method of claim 1, wherein the portion of the available funds are locked from use during an offline payment transaction for a specified type of merchant.

5. The method of claim 1, wherein the portion of the available funds are locked from use during an offline payment transaction involving the user mobile communication device, but are available for use during an offline payment transaction involving a second user mobile communication device.

6. The method of claim 1, wherein the portion of the available funds are locked from use during an offline payment transaction based on one or more rules established by a user of the user mobile communication device.

7. The method of claim 1, wherein the portion of the available funds are locked from use during an offline payment transaction based on one or more rules established by the one or more computing devices.

8. The method of claim 1, further comprising receiving, by the one or more computing devices and from the user mobile computing device, a request to unlock at least a portion of the locked funds.

9. The method of claim 1, wherein the balance certificate is signed by the account management system using a balance certificate private key, and wherein the merchant mobile communication device determines that the balance certificate is valid using a balance certificate public key.

10. The method of claim 1, wherein the merchant mobile communication device determines that the withdrawal record is valid by confirming an identity of a user of the user mobile communication device using an account management system account certificate public key.

11. A computer program product, comprising:
a non-transitory computer-readable medium having computer-readable program instructions embodied therein that when executed by a computer cause the computer to lock funds available for secure offline payments, the computer-readable program instructions comprising:
computer-readable program instructions for receiving, from a user mobile computing device, a request for a balance certificate indicating an amount of funds available for use in an offline payment transaction that will be completed without network access;
computer-readable program instructions for determining that a portion of the available funds are locked from use during the offline payment transaction;
computer-readable program instructions for creating the balance certificate, the balance certificate indicating the amount of funds available for use in the offline payment transaction minus the portion of the available funds are locked from use during the offline payment transaction;
computer-readable program instructions for transmitting the balance certificate to the user mobile communication device; and
computer-readable program instructions for receiving, from a merchant mobile communication device, a withdrawal record for the offline payment transaction between the merchant mobile communication device and the user mobile communication device,
wherein the balance certificate was transmitted by the user mobile communication device to the merchant mobile communication device in response to a payment request for the offline payment transaction, and
wherein the merchant mobile communication device determined that sufficient funds are available for the offline payment transaction by reading the balance certificate; and
computer-readable program instructions for updating, by the one or more computing devices, the amount of funds available for use in a second offline payment transaction.

12. The computer program product of claim 11, wherein the portion of the available funds are locked from use during the offline payment transaction for a pre-defined time period.

13. The computer program product of claim 11, wherein the portion of the available funds are locked from use during the offline payment transaction for a specified location.

14. The computer program product of claim 11, wherein the portion of the available funds are locked from use during an offline payment transaction for a specified type of merchant.

15. The computer program product of claim 11, wherein the portion of the available funds are locked from use during an offline payment transaction involving the user mobile communication device, but are available for use during an offline payment transaction involving a second user mobile communication device.

16. The computer program product of claim 11, wherein the portion of the available funds are locked from use during an offline payment transaction based on one or more rules established by a user of the user mobile communication device.

17. A system for locking funds available for secure offline payments, comprising:
a storage device; and
a processor communicatively coupled to the storage device, wherein the processor executes application code instructions that are stored in the storage device and that cause the system to:
receive, from a user mobile computing device, a request for a balance certificate indicating an amount of funds available for use in an offline payment transaction that will be completed without network access;
determine that a portion of the available funds are locked from use during the offline payment transaction;
create the balance certificate indicating the amount of funds available for use in the offline payment transaction minus the portion of the available funds are locked from use during the offline payment transaction;
transmit the balance certificate to the user mobile communication device; and
receive, from a merchant mobile communication device, a withdrawal record for the offline payment transaction between the merchant mobile communication device and the user mobile communication device,
wherein the balance certificate was transmitted by the user mobile communication device to the merchant mobile communication device in response to a payment request for the offline payment transaction, and
wherein the merchant mobile communication device determined that sufficient funds are available for the offline payment transaction by reading the balance certificate; and
update, by the one or more computing devices, the amount of funds available for use in a second offline payment transaction.

18. The system of claim 17, wherein the portion of the available funds are locked from use during the offline payment transaction for a pre-defined time period or from use during the offline payment transaction for a specified location.

19. The system of claim 17, wherein the portion of the available funds are locked from use during an offline payment transaction involving the user mobile communication device, but are available for use during an offline payment transaction involving a second user mobile communication device.

20. The system of claim 17, wherein the portion of the available funds are locked from use during an offline payment transaction based on one or more rules established by a user of the user mobile communication device.
